(19) United States
(12) Patent Application Publication
(10) Pub. No.: US 2024/0334233 A1
(43) Pub. Date: Oct. 3, 2024

(54) CHANNEL STATE INFORMATION REPORTING IN WIRELESS COMMUNICATIONS

(71) Applicant: ZTE Corporation

(72) Inventors: Guozeng ZHENG, Shenzhen (CN); Hao WU, Shenzhen (CN); Zhaohua LU, Shenzhen (CN); Huahua XIAO, Shenzhen (CN)

(21) Appl. No.: 18/737,318

(22) Filed: Jun. 7, 2024

Related U.S. Application Data
(63) Continuation of application No. PCT/CN2022/086068, filed on Apr. 11, 2022.

(51) Int. Cl. H04W 24/10

(52) U.S. Cl. CPC H04W 24/10

(57) ABSTRACT

This document relates to channel state information (CSI) report and configuration report. A method of wireless communication, comprising receiving, by a wireless communication device, from a network device, a report configuration; and transmitting, by the wireless communication device, to the network device, a channel report according to the report configuration, wherein the report configuration is a channel information report configuration and the channel report is a channel information report.

### CROSS-REFERENCE TO RELATED APPLICATION

This application is a continuation and claims priority to International Application No. PCT/CN2022/086068, filed on Apr. 11, 2022, the disclosure of which is hereby incorporated by reference herein in its entirety.

### TECHNICAL FIELD

This document is directed generally to wireless communications.

### BACKGROUND

Wireless communication technologies are moving the world toward an increasingly connected and networked society. The rapid growth of wireless communications and advances in technology has led to greater demand for capacity and connectivity. Other aspects, such as energy consumption, device cost, spectral efficiency, and latency are also important to meeting the needs of various communication scenarios. In comparison with the existing wireless networks, next generation systems and wireless communication techniques need to provide support for an increased number of users and devices, as well as support an increasingly mobile society.

### SUMMARY

Various techniques are disclosed that can be implemented by embodiments in mobile communication technology, including 5th Generation (5G), new radio (NR), 4th Generation (4G), and long-term evolution (LTE) communication systems with respect to reporting or using channel state information.

In one example aspect, a wireless communication method is disclosed. The method includes receiving, by a wireless communication device, from a network device, a report configuration; and transmitting, by the wireless communication device, to the network device, a channel report according to the report configuration, wherein the report configuration is a channel information report configuration and the channel report is a channel information report.

In another example aspect, another wireless communication method is disclosed. The method includes transmitting, by a network device, to the wireless network device, a report configuration; receiving, by a network device, from a wireless network device, a channel report according to the report configuration; and wherein the report configuration is a channel information report configuration and the channel report is a channel information report.

In yet another exemplary aspect, the above-described methods are embodied in the form of a computer-readable medium that stores processor-executable code for implementing the method.

In yet another exemplary embodiment, a device that is configured or operable to perform the above-described methods is disclosed. The device comprises a processor configured to implement the method.

The above and other aspects and their implementations are described in greater detail in the drawings, the descriptions, and the claims.

### BRIEF DESCRIPTION OF THE DRAWINGS

FIG. 1 shows an example of a wireless communication system that includes a base station (BS) and user equipment (UE).

FIG. 2 is a block diagram example of a wireless communication system

FIG. 3 is a flowchart illustrating an example method.

FIG. 4 is a flowchart illustrating an example method.

FIG. 5 is a flowchart illustrating an example method.

FIG. 6 is a flowchart illustrating an example method.

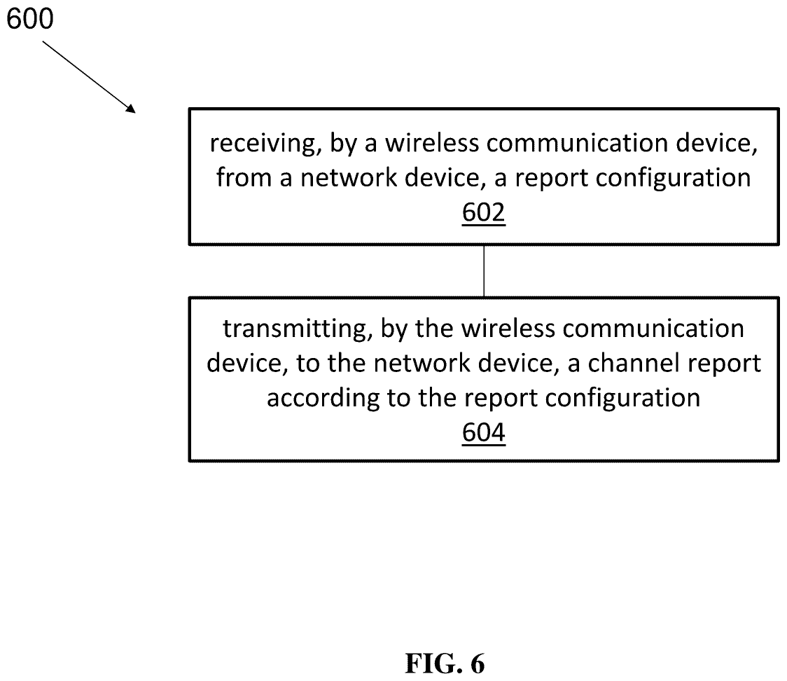

FIG. 7 is a block diagram example of a wireless communication system.

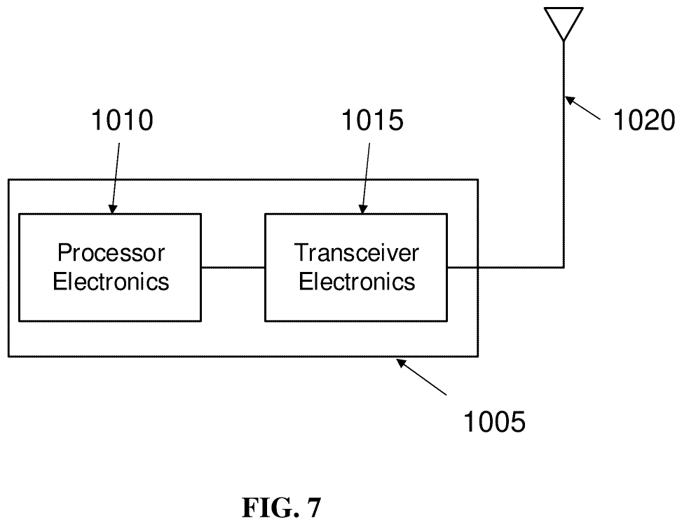

### DETAILED DESCRIPTION

Section headings are used in the present document only to improve readability and do not limit scope of the disclosed embodiments and techniques in each section to only that section. Certain features are described using the example of Fifth Generation (5G) wireless protocol. However, applicability of the disclosed techniques is not limited to only 5G wireless systems.

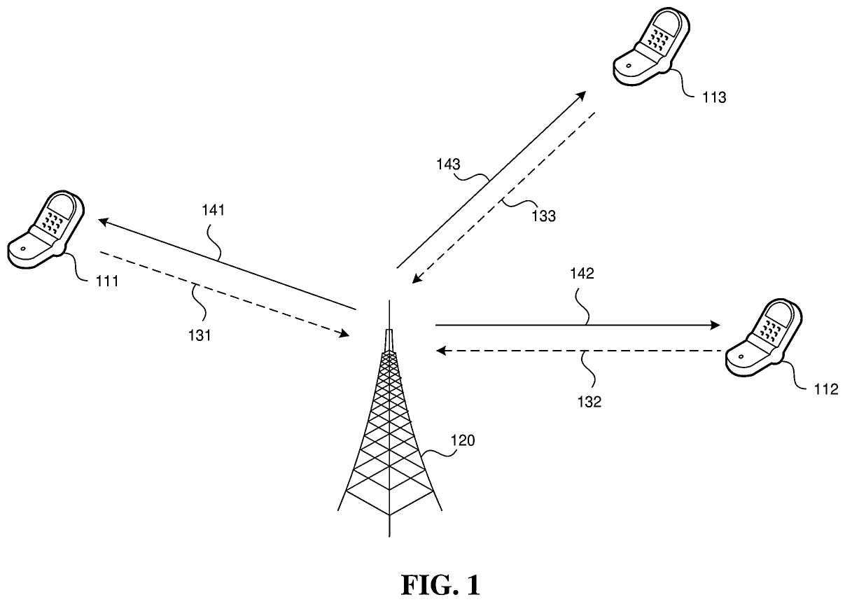

FIG. 1 shows an example of a wireless communication system (e.g., a long term evolution (LTE), 5G or NR cellular network) that includes a BS 120 and one or more user equipment (UE) 111, 112 and 113. In some embodiments, the uplink transmissions (131, 132, 133) can include uplink control information (UCI), higher layer signaling (e.g., UE assistance information or UE capability), or uplink information. In some embodiments, the downlink transmissions (141, 142, 143) can include DCI or high layer signaling or downlink information. The UE may be, for example, a smartphone, a tablet, a mobile computer, a machine to machine (M2M) device, a terminal, a mobile device, an Internet of Things (IoT) device, and so on.

In order to save overhead, the channel measured by UE may not directly report to network in a CSI (channel state information) report. Traditional way is to is to quantize/compress the channel information to get corresponding precoding matrix. However, this traditional way is limited by the tradeoff between overhead and performance. This document proposes methods to resolve problem where UE is unable to calculate the layer indicator (LI) and channel quality indicator (CQI) without the information of reported precoding matrix indicator (PMI) (e.g., via recovered channel), and where network cannot calculate the layer indicator (LI) and channel quality indicator (CQI) for lack of interference measurement information.

In order to save overhead, the channel measured by user equipment (UE) may not directly report to network in a channel state information (CSI) report. One traditional way is to quantize/compress the channel information to get corresponding precoding matrix. For example, the channel information is represented by different variations of vectors to be included in CSI report as precoding matrix (or precoding matrix indicator), which can be:
A Discrete Fourier transform (DFT) vector, or
Kronecker product of multiple DFT vectors, or
Phase rotated DFT vectors to represent channels between UE and base station with multiple antenna groups/panels, or
A set of DFT vectors and corresponding different weighting coefficients, or
Multiple sets of DFT vectors and corresponding different weighting coefficients to represent the channel in spatial domain, time domain and/or frequency domain respectively.

The above traditional methods are still limited by the tradeoff between overhead and performance. As we have seen that machine learning (especially for deep learning) is developing rapidly over past few years, it would be possible that the channel information can be compressed (e.g., via an encoder) into a feature representation (or latent representation/feature map) at UE side, where the overhead to report the feature representation is significantly lower than report the measured channel directly. At network/base station side, a recovered channel that is as close as the measured channel can be acquired from the feature representation (e.g., via a decoder) by various advanced methods. By this way, network can get precise channel information so that the network can do better scheduling according to the precise channel information. The encoder is not limited to a machine learning model, which could also be other algorithms like compressive sensing, principal component analysis etc.

A CSI report may not only include the precoding matrix indicator (or channel measurement result), but also CQI (channel quality indicator), RI (rank indicator), LI (layer indicator) and CRI (channel resource indicator). According to current wireless communication system, the following mechanisms are generally utilized if the above parameters are reported,
LI shall be calculated conditioned on the reported CQI, PMI, RI and CRI
CQI shall be calculated conditioned on the reported PMI, RI and CRI
PMI shall be calculated conditioned on the reported RI and CRI
RI shall be calculated conditioned on the reported CRI.

As described above, LI and CQI should be conditioned on reported PMI. However, after measured channel passes an encoder to obtain the feature representation, there is no way for UE to get reported PMI (e.g., recovered channel) since the decoder maybe implemented at network. UE may only know the feature representation of the measured channel rather than recovered channel by network. Furthermore, CQI/LI depends on channel measurement and interference measurement, where the channel measurement is approximately represented by the reported PMI and interference measurement depends on at least one of the channel noises, intra-layer interference, intra-cell interference, inter-cell interference and etc. The channel measurement (i.e., the feature representation/latent representation/feature map) is the measured channel after passing through an encoder unit in the wireless communication device. The recovered channel is the channel measurement after passing through a decoder unit. Generally, the decoder unit is implemented at network device since the network device can use more advanced/complicated methods to decode the measured channel. Therefore, UE cannot calculate the LI and CQI without the information of reported PMI (e.g., recovered channel). Meanwhile, network cannot calculate the LI and CQI for lack of interference measurement information.

The embodiments and technique described in the present document can be used to resolve the above discussed problem.

In some embodiments, network provides a CSI report configuration to UE, where the CSI report configuration requires UE to report CRI, RI and a feature representation of a measured channel (or a channel measurement) in a CSI report. In this embodiment, the CSI report configuration doesn't require UE to LI and/or CQI in a CSI report.

In some embodiments, network provides a CSI report configuration to UE, where the CSI report configuration requires UE to report RI and a feature representation of a measured channel (or a channel measurement) in a CSI report.

In some embodiments, network provides a CSI report configuration to UE, where the CSI report configuration requires UE to report CRI, RI, a feature representation of a measured channel (or a channel measurement) and interference measurement result(s) in a CSI report. When network obtains the CSI report, network is able to calculate CQI/LI based on the reported CRI, RI, interference measurement result and a recovered channel.

In some embodiments, network provides a CSI report configuration to UE, where the CSI report configuration requires UE to report RI, a feature representation of a measured channel (or a channel measurement) and interference measurement result(s) in a CSI report. When network obtains the CSI report, network is able to calculate CQI/LI based on the reported CRI, RI, interference measurement result and a recovered channel.

In some embodiments, the CSI report configuration should be associated with reference signals, which is used for UE to calculate/measure the interference measurement result(s). Furthermore, UE needs to report index(es) of the reference signals that have been actually used for the calculation of interference measurement result(s), which means UE can select a subset of reference signals associated with the CSI report configuration for the calculation of the interference measurement result(s).

In some embodiments, the CSI report configuration can indicate UE to report wideband interference measurement results.

In some embodiments, the number of wideband interference measurement result in a CSI report is decided by the value of RI. Each value of wideband interference measurement result corresponds to an interference measurement result of a layer. For example, the RI value is 2, so the first wideband interference measurement result corresponds to the interference measurement result of first layer and the second wideband interference measurement result correspond to the interference measurement result of second layer.

In some embodiments, the number of wideband interference measurement result is equal to the square of RI value. For example, the RI value is 2, then the number of wideband interference measurement result is 4. Furthermore, the 4 values may be ordered by the following priority (e.g., from high to low) in a CSI report: the interference measurement result in first layer, the cross-interference (or intra-interference) result in first layer from second layer, the interference measurement result in second layer and the cross interference in second layer from first layer.

In some embodiments, the number of wideband interference measurement result in a CSI report is decided by the value of codeword. Each value of wideband interference measurement result corresponds to interference measurement result of a codeword, where each codeword has considered the interference experienced by multiple layers. For example, there are two wideband interference measurement results reported and the RI value is 4, in which the first wideband interference measurement result corresponds to the first two layers and the second wideband interference measurement result corresponds to the remaining two layers.

In some embodiments, the number of wideband interference measurement result is equal to the square of codeword number, where the codeword number is further decided by the RI value. For example, there are two codewords and the RI value is 4, in which the first codeword corresponds to the first two layers and the second codeword corresponds to the remaining two layers. Therefore, the number of wideband interference measurement result is 4. Furthermore, the 4 values may be ordered by the following priority (e.g., from high to low) in a CSI report: the interference measurement result in first codeword, the cross-interference (or intra-interference) result in first codeword from second codeword, the interference measurement result in second codeword and the cross interference in second layer from first codeword.

In some embodiments, the CSI report configuration can indicate UE to report sub-band interference measurement results.

In some embodiments, the CSI report configuration may further indicate the sub-band list that requires UE to report sub-band interference measurement results.

In some embodiments, the number of sub-band interference measurement result is equal to the RI value. The sub-band interference measurement results for a sub-band include each value of sub-band interference measurement result corresponds to interference measurement result of a layer. For example, the RI value is 2, so the first sub-band interference measurement result corresponds to the interference measurement result of first layer and the second sub-band interference measurement result corresponds to the interference measurement result of second layer.

In some embodiments, the number of sub-band interference measurement result is equal to the square of RI value. For example, the RI value is 2, then the number of sub-band interference measurement result is 4. Furthermore, the 4 values may be ordered by the following priority (e.g. from high to low) in a CSI report: the interference measurement result in first layer, the cross-interference (or intra-interference) result in first layer from second layer, the interference measurement result in second layer and the cross interference in second layer from first layer.

In some embodiments, the number of sub-band interference measurement result is equal to the number of codeword. The sub-band interference measurement results for a sub-band include each value of sub-band interference measurement result corresponds to interference measurement result of a codeword, where each codeword has considered the interference experienced by multiple layers. For example, there are two sub-band interference measurement results reported and the RI value is 4, in which the first sub-band interference measurement result corresponds to the first two layers and the second sub-band interference measurement result corresponds to the remaining two layers.

In some embodiments, the number of sub-band interference measurement result is equal to the square of codeword number, where the codeword number is further decided by the RI value. For example, there are two codewords and the RI value is 4, in which the first codeword corresponds to the first two layers and the second codeword corresponds to the remaining two layers. Therefore, the number of sub-band interference measurement result is 4. Furthermore, the 4 values may be ordered by the following priority (e.g., from high to low) in a CSI report: the interference measurement result in first codeword, the cross-interference (or intra-interference) result in first codeword from second codeword, the interference measurement result in second codeword and the cross interference in second layer from first codeword.

In some embodiments, the sub-band interference measurement results are reported relative to the wideband interference measurement result. Furthermore, the sub-band interference measurement results are reported relative to the wideband interference measurement result that is from the same layer or codeword.

In some embodiments, in order to increase the reliability of interference measurement, one interference measurement result should be based on (or filtered from) multiple interference measurements.

In some embodiments, the network should configure the number of occasions (instances) to calculate the interference measurement result(s). For example, for an interference measurement result measured from a periodical reference signal, network can indicate to UE that an interference measurement result should be based on N consecutive occasions (or instances) of the periodical reference signal.

In some embodiments, in order to increase the reliability of interference measurement, one interference measurement result should be based on (or filtered from) interference measurements within a period (or a window).

In some embodiments, network provides a CSI report configuration to UE, where the CSI report configuration requires UE to report CRI, RI, a feature representation (or latent representation/feature map) of a measured channel (or a channel measurement) and CQI in a CSI report.

In some embodiments, network provides a CSI report configuration to UE, where the CSI report configuration requires UE to report RI, a feature representation (or latent representation/feature map) of a measured channel (or a channel measurement) and CQI in a CSI report.

In some embodiments, network provides a CSI report configuration to UE, where the CSI report configuration requires UE to report CRI, RI, LI, a feature representation (or latent representation/feature map) of a measured channel (or a channel measurement) and CQI in a CSI report. UE should assume that the reported CQI/LI in a CSI report as required by the CSI report configuration is calculated conditioned on one of the following ways:

The reported CQI/LI is calculated conditioned on the recovered channel. By this way, network should provide the decoder unit to UE so that UE is able to decode/obtain the recovered channel. Furthermore, network may configure multiple decoder units to the UE. Then, the network may indicate which decoder unit should be used to decode/obtain the recovered channel.

The reported CQI/LI is calculated conditioned on the measured channel (or the input of encoder). However, the decoder may not be able to get recovered channel accurately. That is, the recover channel has estimation loss compared to measured channel. Therefore, the CQI/LI may be over-estimated if it's based on measured channel.

The channel measurement (or the feature representation) is the measured channel after passing through an encoder unit in the wireless communication device.

The recovered channel is the channel measurement after passing through a decoder unit in the wireless communication device.

In some embodiments, when CQI/LI is calculated conditioned on the measured channel. Furthermore, the CSI report configuration can provide at least a penalty factor to UE. UE should consider the penalty factor when calculating CQI/LI.

The penalty factor can be a power offset. For example, the power offset is the assumed ratio of PDSCH EPRE (Energy Per Resource Element) to EPRE of reference signal when UE derives CSI feedback.

In some embodiments, network may provide multiple encoders to UE, where the CSI report configuration should indicate which encoder to be used to obtain the feature representation. Furthermore, different encoders may be associated with different power offsets.

In some embodiments, each reference signal may be associated with multiple power offsets. The CSI report configuration should indicate which power offset to be used to derive the CSI report.

In some embodiments, the value of power offset can only be less than 1 or 0 dB.

The penalty factor can be a SINR (Signal to Interference plus Noise Ratio) loss. The UE should consider the SINR loss when UE derives CSI feedback. For example, if the SINR loss is −2 dB, and the calculated SINR based on the measured channel and interference measurement 10 dB, then UE should penalize the calculated SINR (i.e., from 10 dB to 8 dB) when calculating the CQI.

In some embodiments, network may provide multiple encoders to UE, where the CSI report configuration should indicate which encoder to be used to obtain the feature representation. Furthermore, different encoders may be associated with different SINR losses.

The CSI report configuration may include wideband penalty factor and/or sub-band penalty factors to UE.

In some embodiments, the wideband penalty factor is applied to the whole frequency range of measured channel

The CSI report configuration may further indicate a list of sub-bands, where each sub-band or a group of sub-bands is provided with a sub-band penalty factor

In some embodiments, each sub-band penalty factor should be provided relative to the wideband penalty factor.

Accordingly, some preferred embodiments may use the following solutions.

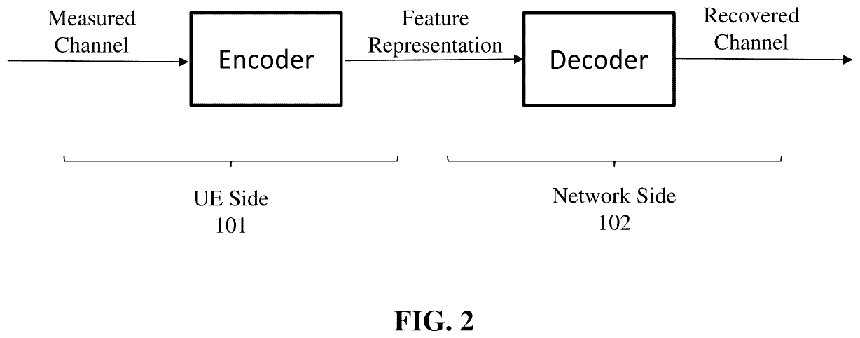

1. A method of wireless communication, as shown in FIG. 2, comprising: receiving, by a wireless communication device (101), from a network device (102), a report configuration; and transmitting, by the wireless communication device (101), to the network device (102), a channel report according to the report configuration, wherein the report configuration is a channel information report configuration and the channel report is a channel information report.

2. The method of claim 1, wherein the report configuration requires the wireless communication device to include a channel resource indicator (CRI), a rank indicator (RI), and a channel measurement in the channel report.

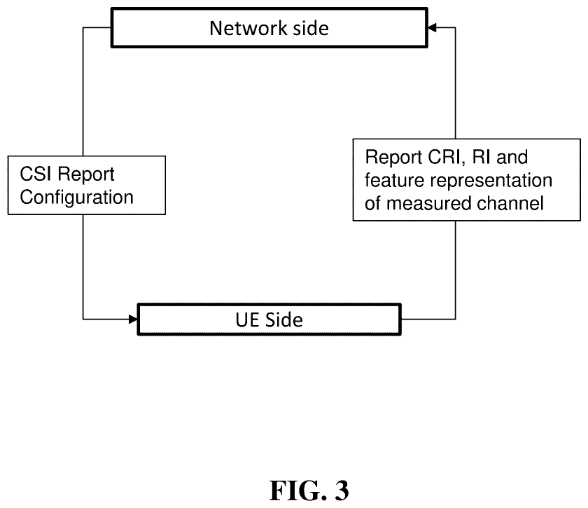

3. The method of claim 2, wherein the report configuration further requires the wireless communication device to include a plurality of interference measurement results in the channel report, as shown in FIG. 3.

4. The method of claim 2, wherein the channel report includes a channel resource indicator (CRI), a rank indicator (RI), and a channel measurement, as shown in FIG. 3.

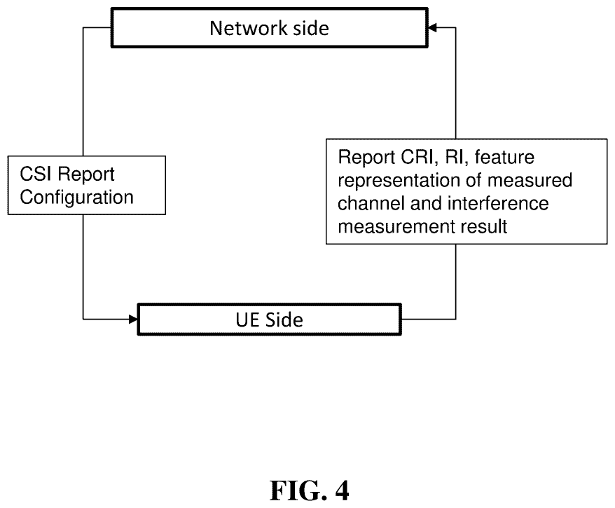

5. The method of claim 3, wherein the channel report includes a plurality of interference measurement results, as shown in FIG. 4.

6. The method of claim 5, wherein the plurality interference measurement results are measured within a time period or from multiple occasions.

7. The method of claim 5, wherein the interference measurement results are wideband interference measurement results.

8. The method of claim 7, wherein each wideband interference measurement results are associated with RI values, where each RI value corresponds to a layer.

9. The method of claim 7, wherein each wideband interference measurement results are associated with codeword, where each codeword corresponds to multiple layers.

10. The method of claim 5, wherein the interference measurement results are sub-band interference measurement results.

11. The method of claim 10, wherein each sub-band interference measurement results are associated with RI values, where each RI value corresponds to a layer.

12. The method of claim 10, wherein each sub-band interference measurement results are associated with codeword, where each codeword corresponds to multiple layers.

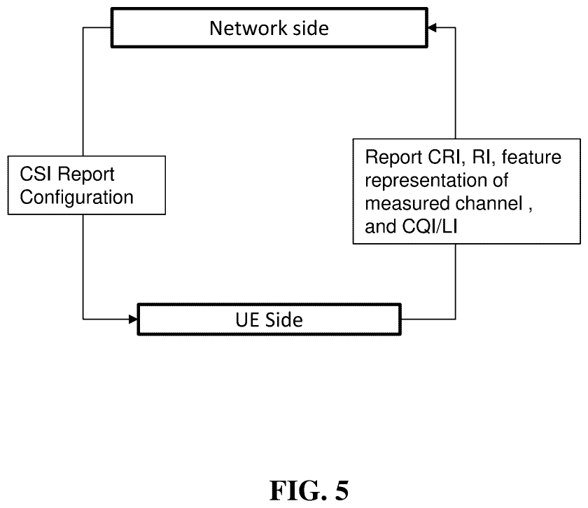

13. The method of claim 2, wherein the report configuration further requires the wireless communication device to include a channel quality indicator (CQI) in channel report, as shown in FIG. 5.

14. The method of claim 13, wherein the report configuration further requires the wireless communication device to include a layer indicator (LI) in the channel report, as shown in FIG. 5.

15. The method of claim 13 wherein the channel report includes a CQI, as shown in FIG. 5.

16. The method of claim 14, wherein the channel report includes a LI, as shown in FIG. 5.

17. The method of claim 15, wherein the CQI is calculated conditioned on a recovered channel.

18. The method of claim 15, wherein the CQI is calculated conditioned on a measured channel.

19. The method of claim 13, the report configuration further comprises penalty factors.

20. The method of claim 16, wherein the LI is calculated conditioned on the recovered channel.

21. The method of claim 16, wherein the LI is calculated conditioned on the measured channel.

22. The method of claim 14, the report configuration further comprises penalty factors.

23. A method of wireless communication, comprising: transmitting, by a network device, to the wireless network device, a report configuration; receiving, by a network device, from a wireless network device, a channel report according to the report configuration; and wherein the report configuration is a channel information report configuration and the channel report is a channel information report.

24. The method of claim 23, wherein the report configuration requires the wireless communication device to include a channel resource indicator (CRI), a rank indicator (RI), and a channel measurement in the channel report.

25. The method of claim 24, wherein the report configuration further requires the wireless communication device to include a plurality of interference measurement results in the channel report.

26. The method of claim 24, wherein the channel report includes a channel resource indicator (CRI), a rank indicator (RI), and a channel measurement.

27. The method of claim 25, wherein the channel report includes a plurality of interference measurement results

28. The method of claim 27, wherein the plurality interference measurement results are measured within a time period or from multiple occasions.

29. The method of claim 27, wherein the interference measurement results are wideband interference measurement results.

30. The method of claim 29, wherein each wideband interference measurement results are associated with RI values, where each RI value corresponds to a layer.

31. The method of claim 29, wherein each wideband interference measurement results are associated with codeword, where each codeword corresponds to multiple layers.

32. The method of claim 27, wherein the interference measurement results are sub-band interference measurement results.

33. The method of claim 32, wherein each sub-band interference measurement results are associated with RI values or square of RI values, where each RI value corresponds to a layer.

34. The method of claim 32, wherein each sub-band interference measurement results are associated with codeword or the square of codeword, where each codeword corresponds to multiple layers.

35. The method of claim 24, wherein the report configuration further requires the wireless communication device to include a channel quality indicator (CQI) in channel report.

36. The method of claim 35, wherein the report configuration further requires the wireless communication device to include a layer indicator (LI) in the channel report.

37. The method of claim 35, wherein the channel report includes a CQI.

38. The method of claim 36, wherein the channel report includes a LI.

39. The method of claim 37, wherein the CQI is calculated conditioned on the recovered channel.

40. The method of claim 37, wherein the CQI is calculated conditioned on the measured channel.

41. The method of claim 35, wherein the report configuration further comprises penalty factors.

42. The method of claim 38 wherein the LI is calculated conditioned on the recovered channel.

43. The method of claim 38, wherein the LI is calculated conditioned on the measured channel.

44. The method of claim 36, the report configuration further comprises penalty factors.

FIG. 2 shows an example of a wireless communication system (e.g., a long term evolution (LTE), 5G or NR cellular network) that includes UE side 101 and Network side 102. The channel information can be compressed (e.g., via an encoder) into a feature representation at UE side, where the overhead to report the feature representation is significantly lower than report the measured channel directly. At network/base station side, the feature representation can be recovered (e.g. via a decoder) as close as the measured channel by various advanced methods.

It will be appreciated that various techniques have been disclosed to allow embodiments to generate and use a channel state information (CSI) report and a configuration report. In order to save overhead, the channel measured by UE may not directly report to network in a CSI (channel state information) report. Traditional way is to is to quantize/compress the channel information to get corresponding precoding matrix. However, this traditional way is limited by the tradeoff between overhead and performance. This document proposes methods to resolve problem where UE is unable to calculate the layer indicator (LI) and channel quality indicator (CQI) without the information of reported precoding matrix indicator (PMI) (e.g., via recovered channel), and where network cannot calculate the layer indicator (LI) and channel quality indicator (CQI) for lack of interference measurement information.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of a document that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described, and other implementations, enhancements, and variations can be made based on what is described and illustrated in this disclosure.

What is claimed is:

1. A method of wireless communication, comprising:
receiving, by a wireless communication device, from a network device, a report configuration; and
transmitting, by the wireless communication device, to the network device, a channel report according to the report configuration,
wherein the report configuration is a channel information report configuration and the channel report is a channel information report,
wherein the channel report includes a channel resource indicator (CRI), a rank indicator (RI), and a channel measurement, and
wherein the channel report includes a plurality of interference measurement results.

2. The method of claim 1, wherein the plurality of interference measurement results comprises wideband interference measurement results.

3. The method of claim 2, wherein each wideband interference measurement result is associated with RI values, each corresponding to a layer, or is associated with one or more codewords, each corresponding to multiple layers.

4. The method of claim 1, wherein the plurality of interference measurement results comprises sub-band interference measurement results.

5. The method of claim 4, wherein each sub-band interference measurement result is associated with RI values, each corresponding to a layer, or is associated with one or more codewords, each corresponding to multiple layers.

6. A method of wireless communication, comprising:
transmitting, by a network device, to a wireless network device, a report configuration;
receiving, by the network device, from a wireless network device, a channel report according to the report configuration,
wherein the report configuration is a channel information report configuration and the channel report is a channel information report,
wherein the channel report includes a channel resource indicator (CRI), a rank indicator (RI), and a channel measurement, and
wherein the channel report includes a plurality of interference measurement results.

7. The method of claim 6, wherein the plurality of interference measurement results comprises wideband interference measurement results.

8. The method of claim 7, wherein each wideband interference measurement result is associated with RI values, each corresponding to a layer, or is associated with one or more codewords, each corresponding to multiple layers.

9. The method of claim 6, wherein the plurality of interference measurement results comprises sub-band interference measurement results.

10. The method of claim 9, wherein each sub-band interference measurement result is associated with RI values or square of RI values, each corresponding to a layer, or is associated with one or more codewords or square of one or more codewords, each corresponding to multiple layers.

11. A device for wireless communication, comprising a processor that is configured to:
receive, from a network device, a report configuration; and
transmit, to the network device, a channel report according to the report configuration,
wherein the report configuration is a channel information report configuration and the channel report is a channel information report,
wherein the channel report includes a channel resource indicator (CRI), a rank indicator (RI), and a channel measurement, and
wherein the channel report includes a plurality of interference measurement results.

12. The device of claim 11, wherein the plurality of interference measurement results comprises wideband interference measurement results.

13. The device of claim 12, wherein each wideband interference measurement result is associated with RI values, each corresponding to a layer, or is associated with one or more codewords, each corresponding to multiple layers.

14. The device of claim 11, wherein the plurality of interference measurement results comprises sub-band interference measurement results.

15. The device of claim 14, wherein each sub-band interference measurement result is associated with RI values, each corresponding to a layer, or is associated with one or more codewords, each corresponding to multiple layers.

16. A device for wireless communication, comprising a processor that is configured to:
transmit, to a wireless network device, a report configuration;
receive, from the wireless network device, a channel report according to the report configuration,
wherein the report configuration is a channel information report configuration and the channel report is a channel information report,
wherein the channel report includes a channel resource indicator (CRI), a rank indicator (RI), and a channel measurement, and
wherein the channel report includes a plurality of interference measurement results.

17. The device of claim 16, wherein the plurality of interference measurement results comprises wideband interference measurement results.

18. The device of claim 17, wherein each wideband interference measurement result is associated with RI values, each corresponding to a layer, or is associated with one or more codewords, each corresponding to multiple layers.

19. The device of claim 16, wherein the plurality of interference measurement results comprises sub-band interference measurement results.

20. The device of claim 19, wherein each sub-band interference measurement result is associated with RI values or square of RI values, each corresponding to a layer, or is associated with one or more codewords or square of one or more codewords, each corresponding to multiple layers.
